(19) United States
(12) Patent Application Publication
(10) Pub. No.: US 2026/0043969 A1
(43) Pub. Date: Feb. 12, 2026

(54) HIGH DENSITY MODULE WITH MULTICORE FIBER DISTRIBUTION

(71) Applicant: viaPhoton, Inc., Aurora, IL (US)

(72) Inventor: Walter Mark HENDRIX, Dallas, TX (US)

(21) Appl. No.: 19/090,131

(22) Filed: Mar. 25, 2025

Related U.S. Application Data
(60) Provisional application No. 63/569,560, filed on Mar. 25, 2024.

(51) Int. Cl. G02B 6/38; G02B 6/44

(52) U.S. Cl. CPC G02B 6/3885; G02B 6/3897; G02B 6/44526; G02B 6/44715

(57) ABSTRACT

An apparatus comprises a module. The module comprising a module housing and an array of Very Small Form Factor (VSFF) connectors extending from a front of the module housing. Each of the VSFF connectors comprises a connector housing having a port at a front end of the connector housing, and a set of optical connections positioned within the port. A trunk cable, comprising a set of optical fibers, extends from the rear of the module housing. Within the module housing, the trunk cable is attached to a fan out module, where the set of optical fibers are broken out into a set of ribbon fibers that are attached to the VSFF connectors.

### CROSS-REFERENCE TO RELATED APPLICATIONS

This Application claims the benefit of U.S. Provisional Application Ser. No. 63/569,560, filed Mar. 25, 2024, which is hereby incorporated by reference for all purposes.

### BACKGROUND

Telecommunications, data centers, and high-performance computing environments rely on optical fiber connectivity to provide faster data transmission rates and higher bandwidths. Connections between optical fibers must support high fiber densities while maintaining low insertion losses. Traditional connectors, however, have often struggled with sensitivity to dust and contaminants, which can significantly degrade performance. Moreover, the physical forces required to insert and secure these connectors have presented challenges in environments where space is at a premium and ease of use is critical.

A Very Small Form Factor (VSFF) Connector is a specialized connector designed to deliver high-performance connectivity while occupying minimal space. The compact size of VSFF connectors is offer a significantly smaller physical footprint compared to traditional connectors such as LC or SC connectors. This compactness also allows for enhanced port density, enabling more connections within the same area and improving the capacity of panels and enclosures.

### SUMMARY

In general, in one aspect, one or more examples relate to an apparatus that comprises a module. The module comprising a module housing and an array of Very Small Form Factor (VSFF) connectors extending from a front of the module housing. Each of the VSFF connectors comprises a connector housing having a port at a front end of the connector housing, and a set of optical connections positioned within the port. A trunk cable, comprising a set of optical fibers, extends from the rear of the module housing. Within the module housing, the trunk cable is attached to a fan out module, where the set of optical fibers are broken out into a set of ribbon fibers that are attached to the VSFF connectors.

In another aspect, one or more examples relate to a method. The method includes providing a set of Very Small Form Factor (VSFF) connectors. Each of the VSFF connectors comprises a connector housing having a port at a front end of the connector housing, and a set of optical connections positioned within the port. A trunk cable, comprising a set of optical fibers, is received at from the rear of the module housing. Within the module housing, the trunk cable is coupled to a fan out module. the set of optical fibers are broken out into a set of ribbon fibers that are attached to the VSFF connectors.

Other aspects of the invention will be apparent from the following description and the appended claims.

### BRIEF DESCRIPTION OF DRAWINGS

FIG. 1 is a rack that is shown in accordance with one or more embodiments.

FIG. 2 is a panel that is shown according to illustrative embodiments.

FIGS. 3A and 3B illustrate a high-density module (212) with an integrated Very Small Form Factor (VSFF) connector system, shown according to illustrative embodiments.

FIG. 4 illustrates a perspective cutaway view of the module, shown according to illustrative embodiments.

FIG. 5 illustrates a block diagram of a fanout module, shown according to illustrative embodiments.

FIGS. 6A and 6B illustrate cross-sectional views of multicore fibers, shown according to illustrative embodiments.

FIG. 7 is a flowchart for a method, shown according to illustrative embodiments.

Like elements in the various figures are denoted by like reference numerals for consistency.

### DETAILED DESCRIPTION

Embodiments of the invention are directed to ...

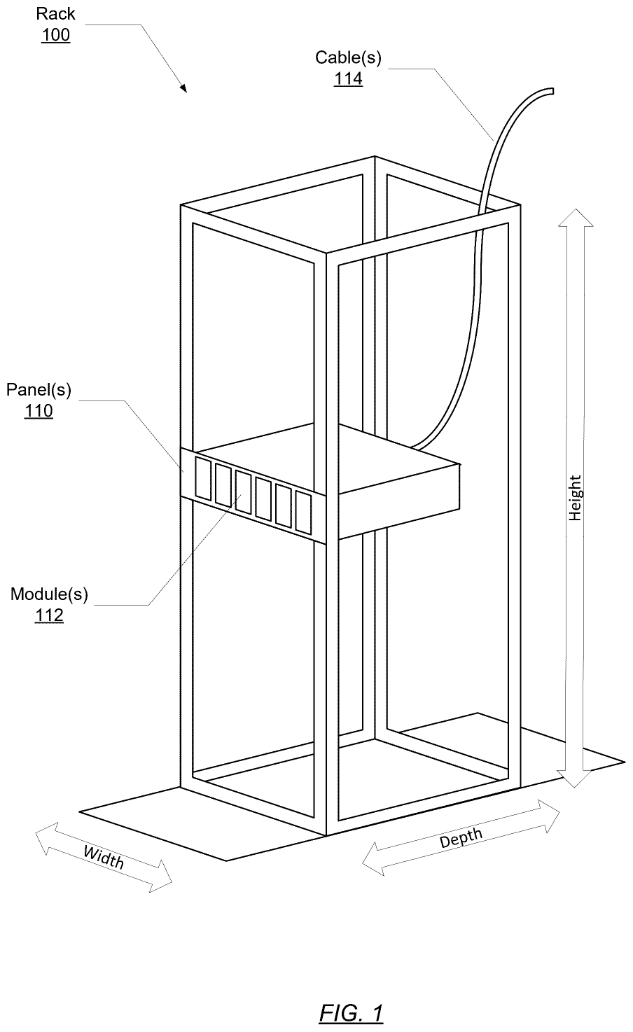

Turning to FIG. 1, a rack is shown in accordance with one or more embodiments. The rack (100) is a piece of telecommunications equipment that provides for the housing and organization of diverse telecommunication devices.

The outer dimensions of rack (100) conform with most network and server equipment. For example, rack width may measure 19 inches (48.26 cm) or 23 inches (58.42 cm) in width, standard measurements that are adhered to in the telecommunications industry. Other dimensions may be used, e.g., 21 inches, 23 inches, etc. The dimensions ensure that the rack can accommodate equipment with different form factors, such as 1 U, 2 U, or larger units, where “U” represents a standard rack unit of measure equal to 1.75 inches in height.

The rack (100) may include a series of uniformly spaced vertical mounting slots, located on both the front and rear, to facilitate the arrangement and mounting of various telecommunication devices and components. The slots serve as attachment points for mounting the panel(s) (110). The rack (100) may further be equipped with additional features such as ventilation openings and cable management.

Panel(s) (110) are components that mount within the rack (100) to organize, secure, and provide access to connective hardware. The panel may be constructed from materials such as steel or aluminum that can support the weight of the modules and withstand the physical demands of a data center environment.

Panel(s) (110) are formed with standardized form factors for compatibility with the mounting slots of the rack (100). For example, the panel(s) (110) may have a form factor corresponding to different rack dimensions, such as 1 U, 2 U, or larger units. The panel(s) (110) may include standardized mounting points to align with rack units, a layout that supports the intended cable or connector density, and provisions for labeling and user accessibility.

The panel(s) (110) may be equipped with one or more module(s) (112) to secure the fibers using ports, connector adapters, connectors, etc. Module(s) (112) are prefabricated units or sub-assemblies designed for quick installation into the rack (100). The module(s) (112) may include electronic components and/or optical components, such as optical connectors, optical fibers, switches, routers, or patches. The module(s) (112) may include features for splicing, cable management, and security.

The module(s) (112) are designed to contain a specific number of optical connectors, optimizing space utilization within the rack mount to support high fiber densities. For example, each module(s) (112) may support fiber densities of 126, 144 fibers, 288 fibers, and/or 576 fibers per module, as well as other suitable densities. The connectors may be an industry-standard connector such as a standard connector (SC), Lucent connector (LC), or Multi-fiber Termination Push-on connector (MTP), depending on the network requirements. In some embodiments, the connectors may be a Very Small Form Factor (VSFF) connector.

The module(s) (112) may have multiple widths, such that a varying number of modules may be housed within the panel(s) (110). The module(s) (112) may be sized to fit twelve (12) modules in the panel(s) (110), however other sizes—e.g., 2, 3, 4, 6, 8—are also contemplated. When fully loaded with module(s) (112), the panel(s) (110) support fiber densities of 1728 fibers, 3456, fibers, and/or 6912 fibers per panel, as well as other suitable densities.

Cable(s) (114) may be fiber optic cables that carry data signals between different network devices and components. Cable(s) (114) are routed through the data center infrastructure, connecting panels, modules, and external devices. For example, cable(s) (114) may interconnect module(s) (112). Cable(s) (114) may include a core, cladding, and protective coating, which ensure the integrity of the data signal. Cable(s) (114) can be single-mode or multi-mode, depending on the network requirements. Cable(s) (114) may be color-coded to facilitate identification during installation and maintenance.

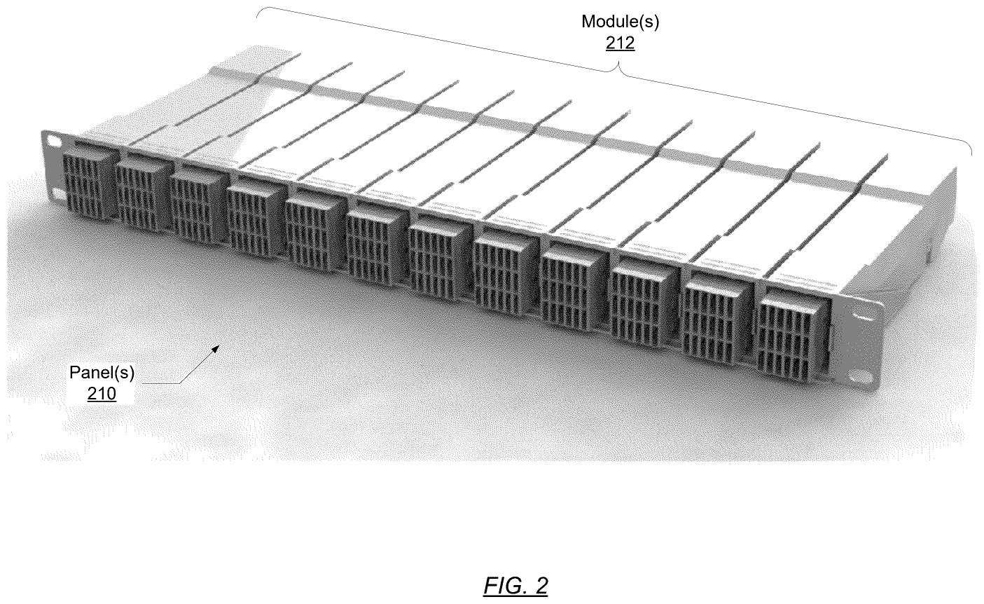

Referring now to FIG. 2, a panel is shown according to illustrative embodiments. The panel (210) is an example of panel (110) of FIG. 1. The panel (210) illustrates a high-density fiber optic panel incorporating multiple modular units (212). The panel (210) is a rack-mountable structure configured to accommodate a set of modules (212) in a linear arrangement along the front face of the panel. The modules (212) are positioned side by side, each housing a set of Very Small Form Factor (VSFF) connectors that extend outward from the front face of the module.

Each module (212) is configured to hold an array of VSFF connectors that facilitate optical connections with external fiber optic cables. The VSFF connectors are arranged in a row along the front face of each module (212), forming an array across the panel (210). The modules (212) are structured to fit within a defined panel height, allowing for a high-density arrangement of fiber optic connections. The panel (210) is configured to be mounted within a standard rack system, enabling the integration of multiple panels within a datacenter or telecommunications environment.

Each VSFF connector within the module (212) includes a connector housing that supports a front-facing port. The module (212) houses a trunk cable that extends from the rear of the module, routing fiber ribbons to corresponding VSFF connectors. The connectors are secured within the module housing, maintaining alignment and positioning for optical connections. The arrangement supports modular installation and removal, enabling reconfiguration and scalability within the fiber optic infrastructure. The structural alignment of the modules (212) and the panel (210) provides a means for organizing high fiber count interconnections within a compact space.

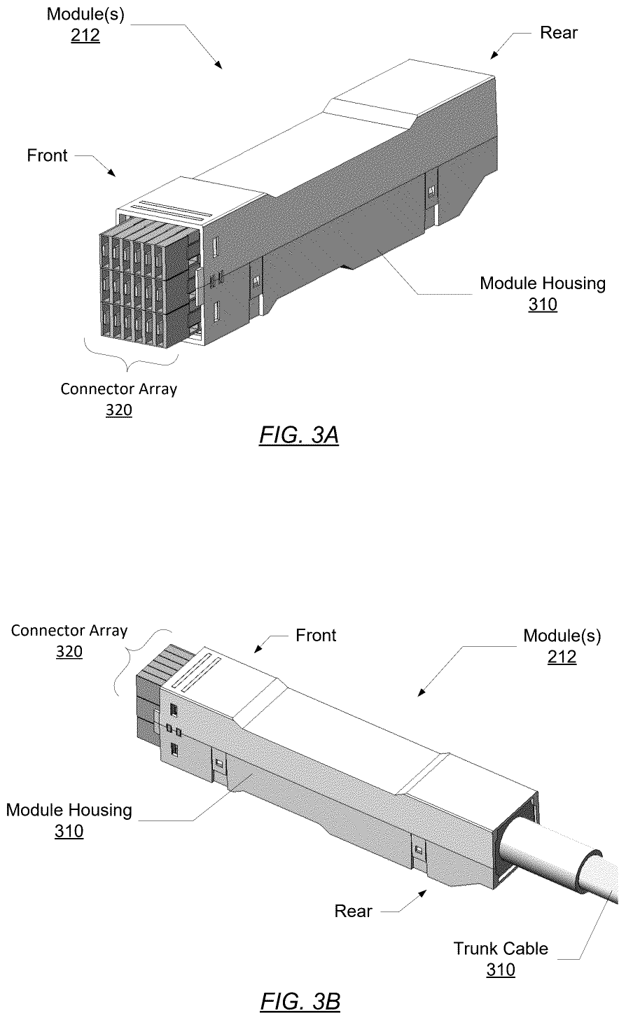

FIGS. 3A and 3B illustrate a high-density module (212) with an integrated Very Small Form Factor (VSFF) connector system. The module (212) comprises a module housing (310) that encloses and supports internal fiber routing and connector integration. The front of the module (212) features a connector array (320), which includes multiple VSFF connectors arranged in a structured configuration for high-density fiber optic connections.

In FIG. 3A, the module housing (310) extends from the front to the rear of the module (212), providing an enclosure for fiber routing and connector alignment. The connector array (320) is positioned at the front of the module, allowing for external fiber connections through VSFF optical interfaces. The structure of the module housing (310) is configured to retain the connectors in a fixed alignment while enabling modular insertion into a rack-mounted panel.

FIG. 3B shows the rear portion of the module (212), where a trunk cable (310) extends outward from the module housing (310). The trunk cable (310) comprises multiple ribbon fibers that are broken out within the module housing (310) and routed to individual connectors within the connector array (320). The positioning of the trunk cable (310) enables fiber management and organization within a structured cable routing system. The module housing (310) provides protection for internal components and maintains fiber alignment between the trunk cable (310) and the connector array (320).

The arrangement of the connectors in the module (212) supports high fiber densities and allows for integration into a larger panel system. The design enables modular insertion and removal, supporting scalability and adaptability in high-density fiber optic environments. For example, panel (200) of FIG. 2 includes space for twelve of the modules (212) that are sized to fit within a 1 U space (1.75 inches) of a 19-inch rack. With two fibers per port, thirty-six ports per module, and twelve modules per panel, the panel (200) supports eight hundred sixty-four (“864”) fibers per panel. With sixteen fibers per port, the panel (200) supports three thousand four hundred fifty-six (“3456”) fibers per panel. With thirty-two fibers per port, the panel (200) supports six thousand nine hundred twelve (“6912”) fibers per panel.

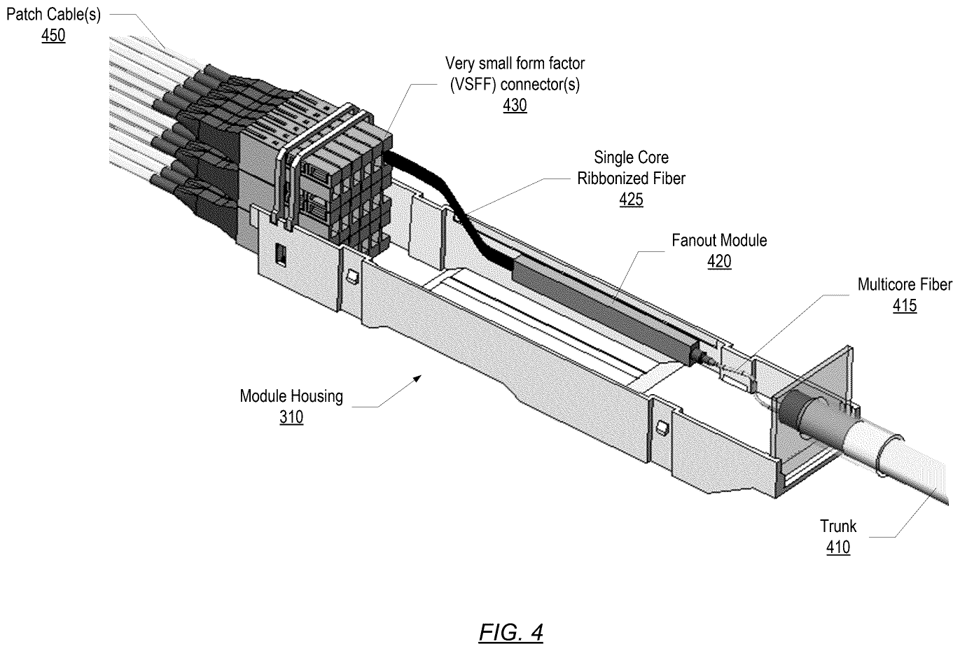

Referring now to FIG. 4, a module is shown according to illustrative embodiments. The module is an example of module (212) of FIG. 2.

As shown, the module comprises a module housing (310) that is configured to contain an array of Very Small Form Factor (VSFF) connectors (430) extending from the front of the module housing (310). The module housing (310) provides structural support and alignment for the internal components. The VSFF connectors (430) are arranged in multiple rows, with at least three rows and at least six connectors per row. Each VSFF connector (430) includes a connector housing having a port at a front end and a set of optical connections positioned within the port.

A trunk cable (410) is received at the rear of the module housing (310). The trunk cable (410) comprises a multicore fiber (415), which is a fiber optic cable containing multiple optical fibers bundled together. The multicore fiber (415) is routed to a fanout module (420) contained within the module housing (310). The fanout module (420) is configured to break out the set of optical fibers from the multicore fiber (415) into individual ribbon fibers or single-core ribbonized fibers (425). The ribbon fibers (425) are routed from the fanout module (420) to the VSFF connectors (430), where they are attached to the optical connections positioned within the ports of the VSFF connectors (430).

The front of the module housing (310) contains the VSFF connectors (430) that are configured to mate with patch cables (450). The patch cables (450) provide external optical connections to the module. The VSFF connectors (430) may support various fiber densities, such as 2, 6, 7, 8, 16, or 32 fibers per connector, depending on the application. The module housing (310) is designed to fit within a 1 U panel, where multiple modules can be arranged horizontally to form a high-density optical connection system. The arrangement allows for scalable integration of VSFF connectors within a confined space.

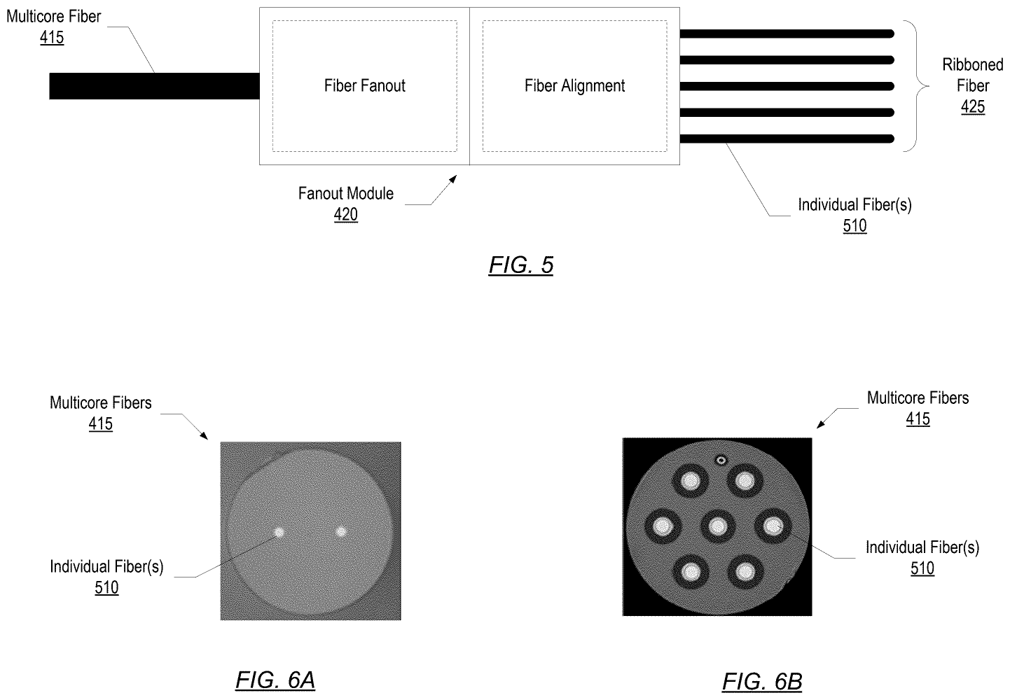

FIG. 5 shows a block diagram of a fanout module according to illustrative embodiments. The fanout module is an example of fanout module (420) of FIG. 4.

As shown, the fanout module 420 is coupled to a multicore fiber 415, which is a single fiber containing multiple cores for transmitting independent data channels. The multicore fiber 415 is connected to a fiber fanout portion, which separates individual fiber cores from the multicore fiber 415.

The separated individual fibers pass through a fiber alignment portion. The fiber alignment portion arranges the individual fibers into a structured configuration, such as parallel alignment for subsequent handling.

The individual fibers 510 are arranged to form a ribboned fiber 425. A ribboned fiber 425 is a configuration where multiple individual fibers are grouped and bonded side-by-side to form a flat, planar structure that allows for organized routing and termination.

The fanout module 420 serves to convert a multicore fiber 415 into individual fibers 510 that are aligned and potentially ribboned to form the ribboned fiber 425. This configuration allows for easy connectivity to VSFF connectors or other optical components.

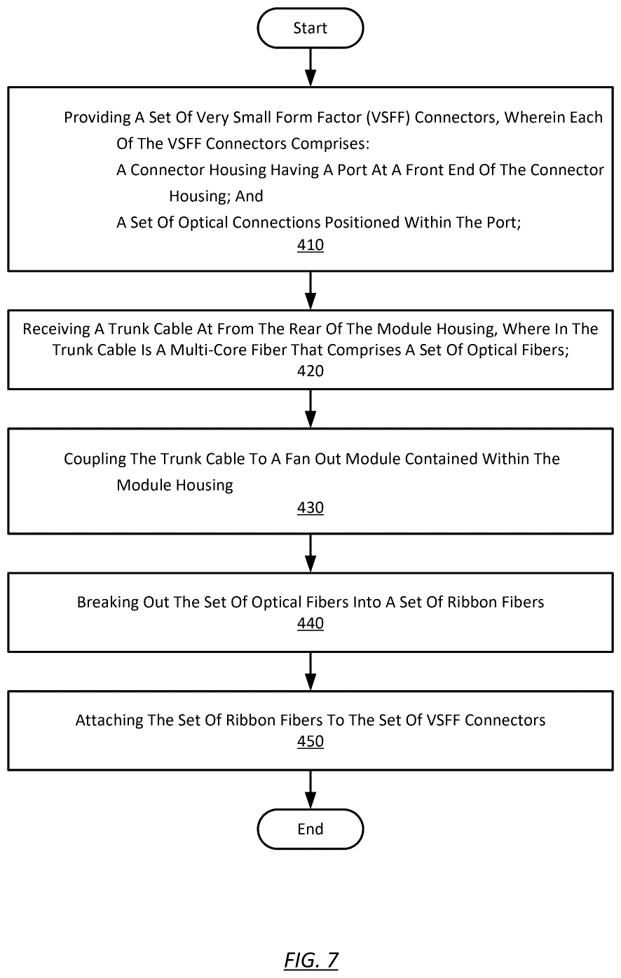

FIGS. 6A and 6B show cross-sectional views of multicore fibers 415.

FIG. 6A shows a multicore fiber 415 with two individual fibers 510 arranged within a common cladding. The individual fibers 510 are separate cores capable of transmitting independent optical signals within a single optical structure.

FIG. 6B shows a multicore fiber 415 with seven individual fibers 510 arranged in a hexagonal pattern within a common cladding. The individual fibers 510 are separated spatially but share the same protective cladding, allowing for higher data transmission density within a single fiber structure.

The multicore fibers 415 depicted in FIGS. 6A and 6B can be used in conjunction with the fanout module 420 to separate and align individual fibers 510 for connection to various optical components, such as VSFF connectors or ribboned fibers.

Turning now to FIG. 7 a flow chart for a method is shown in accordance with one or more embodiments. The flowchart of FIG. 7 shows a process of providing, coupling, and assembling an array of VSFF connectors, such as the connector array (320) of FIG. 3.

In step 410, a set of VSFF connectors is provided. Each VSFF connector includes a connector housing having a port at a front end of the connector housing. The connector housing serves as a protective structure for supporting optical connections. The set of optical connections positioned within the port enables interfacing with individual optical fibers or ribboned fibers for signal transmission.

In step 420, a trunk cable is received at the rear of the module housing. The trunk cable is a multicore fiber that comprises a set of optical fibers within a common cladding. The trunk cable delivers multiple optical transmission paths to the module housing for subsequent breakout and connection to the VSFF connectors.

In step 430, the trunk cable is coupled to a fanout module contained within the module housing. The fanout module separates the individual optical fibers from the multicore fiber of the trunk cable. The fanout module includes components for aligning and organizing the individual fibers to facilitate connection to subsequent components of the module.

In step 440, the set of optical fibers separated by the fanout module is broken out into a set of ribbon fibers. The breakout process involves arranging individual fibers into a parallel, planar configuration, forming a ribboned structure that enables organized connection and routing within the module housing.

In step 450, the set of ribbon fibers is attached to the set of VSFF connectors. Each ribbon fiber is connected to a corresponding VSFF connector, enabling optical signal transmission from the trunk cable through the connectors. The attachment process ensures proper alignment and connectivity of the fibers to the connectors, allowing the module to interface with external devices or systems.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and. ” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. An apparatus comprising a module, the module comprising:
a module housing;
an array of Very Small Form Factor (VSFF) connectors extending from a front of the module housing, wherein each of the VSFF connectors comprises:
a connector housing having a port at a front end of the connector housing; and
a set of optical connections positioned within the port;
a trunk cable extending from the rear of the housing, wherein the trunk cable comprises a set of optical fibers; and
a fan out module contained within the module housing, wherein the set of optical fibers are broken out from the trunk cable into a set of ribbon fibers that are attached to the VSFF connectors.

2. The apparatus of claim 1, wherein the array of VSF connectors further comprise:
at least three rows of VSFF connectors disposed within the front end of the module; and
at least six VSFF connectors per row within the front end of the module.

3. The apparatus of claim 1, wherein:
each VSFF connectors supports a fiber density of 2, 6, 7, 8, 16 fibers or 32 fibers per connector;
the module is configured to hold the array of VSFF connectors, wherein the array includes 9, 12, 15, or 18 VSFF connectors.

4. The apparatus of claim 1, further comprising:
a panel, wherein the module is sized to fit 12 modules within a 1 U panel.

5. The apparatus of claim 4, further comprising:
a plurality of modules, including the module, horizontally placed within the panel, wherein the plurality of modules comprises at least twelve modules.

6. The apparatus of claim 5, wherein the array comprises eighteen VSFF connectors, within a 1 U height, of 216 couplers of the panel comprising a set of twelve modules including the module, providing 864 fibers using the 216 couplers.

7. The apparatus of claim 5, wherein the array comprises eighteen VSFF connectors, within a 1 U height, of 216 couplers of the panel comprising a set of twelve modules including the module, providing 3456 fibers using the 216 couplers.

8. The apparatus of claim 5, wherein the array comprises eighteen VSFF connectors, within a 1 U height, of 216 couplers of the panel comprising a set of twelve modules including the module, providing 6912 fibers using the 216 couplers.

9. A method comprising:
providing a set of Very Small Form Factor (VSFF) connectors, wherein each of the VSFF connectors comprises:
a connector housing having a port at a front end of the connector housing; and
a set of optical connections positioned within the port;
receiving a trunk cable at from the rear of the module housing, where in the trunk cable is a multi-core fiber that comprises a set of optical fibers;
coupling the trunk cable to a fan out module contained within the module housing;
breaking out the set of optical fibers into a set of ribbon fibers; and
attaching the set of ribbon fibers to the set of VSFF connectors.

10. The method of claim 9, wherein the array of VSF connectors further comprise:
at least three rows of VSFF connectors disposed within the front end of the module; and
at least six VSFF connectors per row within the front end of the module.

11. The method of claim 9, wherein:
each VSFF connectors supports a fiber density of 2, 6, 7, 8, 16 fibers or 32 fibers per connector;
the module is configured to hold the array of VSFF connectors, wherein the array includes 9, 12, 15, or 18 VSFF connectors.

12. The method of claim 9, further comprising:
a panel, wherein the module is sized to fit 12 modules within a 1 U panel.

13. The method of claim 12, further comprising:
a plurality of modules, including the module, horizontally placed within the panel, wherein the plurality of modules comprises at least twelve modules.

14. The method of claim 13, wherein the array comprises eighteen VSFF connectors, within a 1 U height, of 216 couplers of the panel comprising a set of twelve modules including the module, providing 864 fibers using the 216 couplers.

15. The method of claim 13, wherein the array comprises eighteen VSFF connectors, within a 1 U height, of 216 couplers of the panel comprising a set of twelve modules including the module, providing 3456 fibers using the 216 couplers.

16. The method of claim 13, wherein the array comprises eighteen VSFF connectors, within a 1 U height, of 216 couplers of the panel comprising a set of twelve modules including the module, providing 6912 fibers using the 216 couplers.

17. A module comprising:
a module housing;
an array of Very Small Form Factor (VSFF) connectors extending from a front of the module housing, wherein each of the VSFF connectors comprises:
a connector housing having a port at a front end of the connector housing; and
a set of optical connections positioned within the port;
a trunk cable extending from the rear of the housing, wherein the trunk cable comprises a set of optical fibers; and
a fan out module contained within the module housing, wherein the set of optical fibers are broken out from the trunk cable into a set of ribbon fibers that are attached to the VSFF connectors.

18. The module of claim 17, wherein the array of VSF connectors further comprise:
at least three rows of VSFF connectors disposed within the front end of the module; and
at least six VSFF connectors per row within the front end of the module.

19. The module of claim 17, wherein:
each VSFF connectors supports a fiber density of 2, 6, 7, 8, 16 fibers or 32 fibers per connector;
the module is configured to hold the array of VSFF connectors, wherein the array includes 9, 12, 15, or 18 VSFF connectors.

20. The module of claim 17, wherein the module is sized to fit 12 modules within a 1 U panel.
